(19) United States
(12) Patent Application Publication
(10) Pub. No.: US 2011/0138373 A1
(43) Pub. Date: Jun. 9, 2011

(54) METHOD AND APPARATUS FOR GLOBALLY OPTIMIZING INSTRUCTION CODE

(75) Inventors: Robert M. Lane, Auburn, CA (US); Akiko Kobiyashi, Palo Alto, CA (US); John Drake, Newport Beach, CA (US)

(73) Assignee: AMERICAN NATIONAL LABORATORIES, INC., Auburn, CA (US)

(21) Appl. No.: 12/963,519

(22) Filed: Dec. 8, 2010

Related U.S. Application Data
(60) Provisional application No. 61/267,726, filed on Dec. 8, 2009.

(51) Int. Cl. G06F 9/45

(52) U.S. Cl. 717/157

(57) ABSTRACT

The disclosed embodiments provide a system that globally optimizes instruction code. During operation, the system obtains the instruction code, wherein the instruction code was previously generated from the source code, and wherein the instruction code is stored along with symbol table information. Next, the system constructs a symbol table from the symbol table information stored along with the instruction code. The system then creates a data structure for the instruction code, wherein the data structure contains a call graph for the instruction code, and wherein creating the data structure involves accessing the symbol table. Finally, the system performs optimizations on the instruction code to produce optimized instruction code, wherein performing the optimizations involves accessing the data structure.

### RELATED APPLICATION

This application hereby claims priority under 35 U.S.C. §119 to U.S. Provisional Application No. 61/267,726, entitled “Method and Apparatus to Optimize Interpreted Computer Programming Languages Using Complier Optimizations,” by inventors Robert. M. Lane, Akiko Kobayashi and John Drake, filed 8 Dec. 2009 (Atty. Docket No. ANL10-1001PSP).

### BACKGROUND

1. Field

The disclosed embodiments generally relate to techniques for optimizing computer instruction code for which corresponding source code may be unavailable.

2. Background

Many computer programming languages interpret bytecode using a virtual machine. Programmers using such languages do not need to worry about the target machine as long as a virtual machine, also known as a “bytecode interpreter,” is available. For example, Java™ is one of the best-known languages that make use of bytecode, and Java compilers are available for desktop and laptop computers, as well as for phones and other devices. This allows programmers to write computer code without regard to the underlying hardware or operating system.

In the following disclosure, the Java language is used to illustrate a technique for optimizing bytecode. However, other programming languages which are reduced to bytecode can be optimized in the same way. The same techniques can also be applied to other programming languages that do not use bytecode, and which have compilers that produce machine code for specific processors or cores. Both bytecode and machine code belong to a class of instructions which are collectively referred to as “instruction code.”

Programming languages that produce bytecode that runs within a virtual machine have device independence much like interpreted programming languages. Unfortunately, programming languages that are reduced to bytecode are frequently unoptimized. To improve the performance of such bytecode, “just-in-time compilation” (JIT) techniques can be used to optimize portions of the code path. However, a program which is optimized using such techniques is not optimized globally. Also, languages that are reduced to machine code are frequently suboptimal for particular hardware implementations. For example, a compiler can emit generic machine code that executes on all processors and cores that execute an instruction set, but the emitted code may not take advantage of specific implementation features such as multiple cores, multiple threads, graphic processor unit processing capabilities, etc.

Hence, what is needed is a method and an apparatus for optimizing bytecode, machine code or interpreted code without the above-described problems.

### SUMMARY

The disclosed embodiments provide a system that globally optimizes instruction code. During operation, the system obtains the instruction code, wherein the instruction code was previously generated from source code, and wherein the instruction code is stored along with symbol table information. Next, the system constructs a symbol table from the symbol table information stored along with the instruction code. The system then creates a data structure for the instruction code, wherein the data structure contains a call graph for the instruction code, and wherein creating the data structure involves accessing the symbol table. Finally, the system performs optimizations on the instruction code to produce optimized instruction code, wherein performing the optimizations involves accessing the data structure.

In some embodiments, the instruction code is either platform-independent byte code or architecture-specific machine code.

In some embodiments, obtaining the instruction code involves interpreting the source code to produce the instruction code.

In some embodiments, constructing the symbol table involves: constructing a list of classes which includes attributes of the classes; and determining an entry point for the instruction code.

In some embodiments, creating the data structure for the instruction code involves storing methods and variables from the instruction code in the data structure.

In some embodiments, the system also performs a shrinking operation on the instruction code, wherein performing the shrinking operation involves removing unnecessary code and variables and also relocating code and variables and updating associated pointers.

In some embodiments, performing the optimizations on the instruction code involves one or more of the following: removing dead code and variables; hoisting loop invariants; loop unrolling; applying transformations to control-flow and data-flow; reusing variables; eliminating common sub-expressions; reducing copy propagation; inlining functions; dropping unnecessary induction variables from loops; algebraic transformations; and choosing an efficient code construct from multiple functionally equivalent code constructs.

In some embodiments, producing the optimized instruction code additionally involves obfuscating the instruction code.

### BRIEF DESCRIPTION OF THE FIGURES

FIG. 1 illustrates the process of optimizing a bytecode file in accordance with the disclosed embodiments.

FIG. 2 illustrates an exemplary use case in accordance with the disclosed embodiments.

FIG. 3 illustrates system components involved in the optimization process in accordance with the disclosed embodiments.

FIG. 4A illustrates a high-level process flow for the optimization process in accordance with the disclosed embodiments.

FIG. 4B illustrates detailed steps involved in the optimization process in accordance with the disclosed embodiments.

FIG. 5 illustrates operations performed by an optimizer state machine in accordance with the disclosed embodiments.

FIG. 6 illustrates files and data structures involved in the optimization process in accordance with the disclosed embodiments.

FIG. 7 illustrates a portion of a data structure for an exemplary piece of code in accordance with the disclosed embodiments.

FIG. 8 illustrates a number of optimizations applied to various objects in accordance with the disclosed embodiments.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Definitions

Assembly code: Assembly languages are a family of low-level languages for programming computers, microprocessors, microcontrollers, and other (usually) integrated circuits. They implement a symbolic representation of the numeric machine codes and other constants needed to program a particular CPU architecture. This representation is usually defined by the hardware manufacturer, and is based on abbreviations (called mnemonics) that help the programmer remember individual instructions, registers, etc. An assembly language is thus targeted at a specific physical or virtual computer architecture (as opposed to most high-level languages, which are usually portable).

Bytecode: An instruction set designed for efficient execution by a software interpreter and that may be compiled to machine code. Bytecode provides machine and operating system independence so that a program is executed on a virtual machine. Examples of languages that use bytes codes that are interpreted by a virtual machine are Java, Python, and Microsoft .NET Common Intermediate Language. Bytecode is virtualized instruction code.

Class: In object-oriented programming, a class has an interface and a structure. The interface describes how to interact with instances of the class, and the structure describes the data within an instance.

Compile time: Compile time refers either to the operations performed by a compiler (the “compile-time operations”), programming language requirements that must be met by source code for it to be successfully compiled (the “compile-time requirements”), or to properties of the program that can be reasoned about at compile time.

Compiler: A program that decodes instructions written in a higher order language and produces an assembly language program.

Compiled language: A compiled language is a programming language that uses a compiler to generate machine code from source code. Examples of compiled languages include Ada, C, C++, Objective-C, COBOL, FORTRAN, Modula-3, and Pascal.

ECMAScript: ECMAScript is a scripting language, standardized by Ecma International in the ECMA-262 specification, ISO/IEC 16262, and other specifications. The language is widely used on the web, especially in the form of its three best-known dialects, JavaScript, ActionScript, and JScript.

Field: A field is part of a larger logical or programmatic set of data. Examples include bit fields, elements of data structures, database tuples, etc. A date can be considered a set of fields: year, month, day, day of week, day of year, etc.

Function: A function is a portion of code within a larger program that performs a specific task or tasks.

High-level language: A high-level programming language is a programming language with strong abstraction from the details of the computer. In comparison to low-level programming languages, it may use natural language elements, be easier to use, or be more portable across platforms. Such languages hide the details of CPU operations such as memory access models and management of scope.

Inline expansion: Inline expansion or inlining is a compiler optimization technique that replaces a function call site with the body of the callee. This may improve time and space usage at run-time Inlining removes the performance overheads of setting up a function call, performing the return, and function tear down. It improves cache performance by improving locality of reference. In addition, the inlined callee body may be subject to additional optimization with the caller.

Instruction code: A code used to represent the instructions in a virtualized (bytecode) or actual (machine code) hardware instruction set.

Intermediate language: An intermediate language is the language of an abstract machine designed to aid in the analysis of computer programs. The term comes from its use in compilers, where a compiler first translates the source code of a program into a form more suitable for code-improving transformations, as an intermediate step before generating object or machine code for a target machine.

Interpreted source code: Source code for computer programming languages that are intended to be executed by an interpreter.

Interpreter: An interpreter is a computer program that executes instructions written in an interpreted programming language. Source code is executed in a step-by-step manner.

Interpreted language: An interpreted language is a programming language whose programs are not directly executed by the host CPU but rather executed (or said to be interpreted) by a software program known as an interpreter. Examples include APL, BASIC, ECMA, JavaScript, Mathematica, Perl, PHP, R, and Ruby.

JavaScript: JavaScript is an object-oriented scripting language used to enable programmatic access to objects within both the client application and other applications. It is primarily used in the form of client-side JavaScript, implemented as an integrated component of the web browser, allowing the development of enhanced user interfaces and dynamic websites. JavaScript is a dialect of the ECMAScript standard and is characterized as a dynamic, weakly typed, prototype-based language with first-class functions. JavaScript was influenced by many languages and was designed to look like Java, but to be easier for non-programmers to work with.

Just-in-time compilation: Just-in-time compilation (JIT), also known as dynamic translation, is a technique for improving the run-time performance of a computer program. JIT builds upon two earlier ideas in run-time environments: bytecode compilation and dynamic compilation. It converts code at run-time prior to executing it natively, for example bytecode into native machine code. Java and Python are examples of computer programming languages that perform just-in-time compilation.

JVM: Java Virtual Machine interprets a language called Java bytecode. Many languages run on top of the JVM: MIDIetPascal, Clojure, Groovy, and Scala were designed specifically for the JVM. Resin Professional compiles PHP to Java bytecode. NetRexx is a variant of Rexx that runs on the JVM.

Machine code: A system of instructions executed directly by the computer's central processing unit (CPU) or core. Machine code should not be confused with bytecode that is executed by an interpreter.

Method: A method is a routine associated with a class or object to perform a task. It is similar to a function. Methods provide a mechanism for accessing and manipulating the encapsulated data stored in an object.

Optimizer: Compiler optimization is the process of tuning the intermediate representation of a program by a compiler to minimize or maximize some attribute of an executable computer program. The most common requirement is to minimize the time taken to execute a program; a less common one is to minimize the amount of memory occupied.

Parse: A computer procedure that includes, but is not limited to, the analysis of a character string or text into logical syntactic components, typically in order to comprehend the meaning or purpose of the text. This procedure includes, but is not limited to, tasks such as removal of white space and comments, identification of constants, and recognition of identifiers and keywords. It may need to read ahead to determine if a “>” is followed by an “=”. If it is followed by “=” then it is a “greater than or equals” operator; otherwise, it is a “greater than” operator. An “if” keyword may be followed by an “else” keyword to form an if-else construct; otherwise, it is simply a condition.

Peephole optimization: Peephole optimization is performed on a limited group of instructions to improve program execution. Peephole optimizations include replacing slow instructions with faster ones, removing redundant code, evaluating constant sub-expressions, simplifying or reordering operations, etc.

Personal compute device: A portable miniature computer that has phone capability. These devices are highly portable. Their utility makes them a necessity rather than a luxury. The demarcation between mobile telecommunication devices (e.g., cellular phones) and personal computers has been merging for several years and is likely to continue with the introduction of phones using sophisticated operating systems (e.g., Linux or Solaris), processor/core technology, services, and mobile telecommunication technology.

Tail recursion: Tail recursion is a special case of recursion in which any last operation performed by the function is a recursive call, the tail call, or returns a (usually simple) value without recursion. Recursion is the process a function goes through when one of the steps of the procedure involves rerunning the procedure.

Token: Tokens are terminal symbols in the grammar for the source language.

Translator: A translator takes a program and generates another program. It is important that the derived program be semantically equivalent to the original, relative to a particular formal semantics. Other program transformations may generate programs that semantically differ from the original in predictable ways.

Variable: A variable is a symbolic name associated with a value and whose associated value may be changed. Sometimes these symbolic names are used as labels for constants. The name is used independently of the value it represents.

### Overview

This patent disclosure describes a system for applying global compiler optimizations to programs that have been reduced to instruction code, wherein corresponding source code may or may not be available. During this process, program components (e.g., objects, classes, variables, interfaces, etc.) that are irrelevant to the functionality of the program are eliminated, and labels are renamed using program scoping rules. The result is more compact code that executes more efficiently in the targeted environment. A significant advantage of this invention is that static instruction code can be optimized without benefit of source code. The system directly manipulates instruction code to optimize the execution, memory requirements, and object management by the virtual or real machine. Furthermore, instruction code can be optimized to take advantage of threads, cores, processors, and other hardware resources in real machines. Thus, the present invention effectively improves performance of instruction code compiled from programming languages that target virtual or real machines.

Note that the performance improvement of Just-in-time (JIT) compilation over interpreters results from caching the results of translated blocks of code, and not simply reevaluating each line of code or operand. JIT also has advantages over statically compiling the code at development time, because a JIT system can recompile the code if it is advantageous to do so, and may be able to enforce security guarantees by optimizing the code in ways that obfuscate the otherwise plain readability of the instruction code.

JIT code generally offers far better performance than interpreters. In addition, it can in some cases offer better performance than static compilation, because many optimizations are only feasible at run-time. More specifically, a JIT compilation system has the following advantages.
(1) Bytecode, like interpreted source code, is platform agnostic. The JIT compiler compiles and caches code at run-time for the targeted CPU and operating system wherever the application runs.
(2) The system is able to collect statistics about how code is actually running in the environment it is in, and it can rearrange and recompile the code for optimum performance.
(3) The system can perform code optimizations (e.g., inlining of library functions) without losing the advantages of dynamic linking and without the overheads inherent to static compilers and linkers.

Nevertheless, languages that use JIT compilation may have run-time optimizer limitations (e.g., multidimensional array sizes, loops with dependencies on external functions or conditionals, nested loops, etc.) that inhibit the existing optimizers. Furthermore, optimization is an NP-complete problem, which means that more complex optimizations require non-polynomial time. Hence, it may not be efficient to optimize such code in real-time. Also, a JIT compiler cannot afford to perform in real-time all the optimizations that are performed by a static compiler. Additionally, a JIT compiler has a limited view of the program, which hampers its ability to optimize code.

Note that, globally, optimization has a number of advantages. For example, global optimization can reduce a program's memory footprint on disk and in memory. This reduces the probability of paging and swapping. Cache conflicts may also be reduced because memory is less likely to be mapped to the same cache line. Also, needless calculations can be eliminated, and variables that share the same values can be combined. Additionally, efficient operations can be used in place of inefficient operations.

One can perform whatever optimizations are possible based on static analysis and emitting restructured instruction code that is optimized. Consequently, instruction code is the target for static compiler optimization with optimized instruction code emitted. Furthermore, bytecode benefits from static optimizations that a JIT compiler cannot perform and dynamic run-time optimizations that a static compiler's optimizer cannot perform.

The optimizations described herein fall into two broad classifications: compiler optimizations and emitted code optimizations. Compiler optimizations include but are not limited to removing dead code and variables, improving loops by hoisting invariants, loop unrolling, applying transformations to control-flow and data-flow, reusing variables, eliminating common sub-expressions, reducing copy propagation, inlining functions, dropping unnecessary induction variables from loops, algebraic transformations, aliasing, etc. Emitted code optimizations are related to choosing the most efficient code construct that is functionally equivalent. For example, equivalent code can be written using for( ) and while( )-do loops; however, one control statement might execute more efficiently because of the underlying implementation. Also, wherever variables have limited use in a function, it may be possible to use the variable for another purpose. Moreover, wherever the code emitter must choose between functionally equivalent alternatives, the choice can be made based on data from micro-benchmarks.

Simply stated, the disclosed system for optimizing instruction code using compiler optimizations logically stands between a compiler's emitted instruction code and target machine (virtual or real).

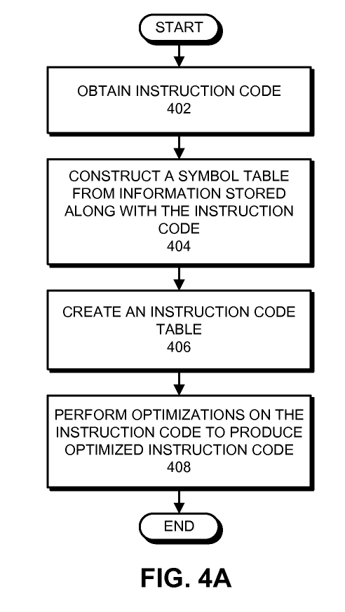

As illustrated in FIG. 3, key components for an instruction code optimizer include an instruction code parser and interpreter 304, a state machine 306 with awareness of what will be executed, a symbol table 312, an instruction code table 310, an offset table 314 to manage code rewrite, a conditional pattern matcher 308 that finds optimization opportunities, and a code emitter 316. The state machine 306 is constructed by semantic and syntactic analyzers operating on the original bytecode. During the optimization process, the functionality of the optimized instruction code is compared with the original. This ensures that the same inputs produce the same outputs even though the instructions are undergoing change.

This technique has a number of advantages which are listed below.
(1) The programmer can focus on writing clear code when the code can be restructured to be efficient without changing what the program does.
(2) Device independence of bytecode is preserved. The optimized bytecode runs in all environments in which the original bytecode runs.
(3) All tokens are identified. Unused tokens are eliminated.
(4) Ambiguities in the original instruction code are identified. Base source code becomes more robust and reliable.
(5) Statements become syntactically and semantically correct, eliminating run-time errors and error recovery.
(6) Code is optimized. Response times and hardware utilization are reduced. This improves customer experience and reduces demand for cores, caches, memory, and busses.
(7) Code can be obfuscated. Security of code is improved. Unobfuscated code can be used for profiling so inefficient algorithms can be identified and improved.
(8) Variable and function name lengths can be reduced by renaming. For programs that are downloaded from a host to a client system, the bandwidth is reduced and download times are faster.

Hence, reverse engineering is made more difficult, bandwidth requirements are reduced, file transfer times are quicker, and execution times improved.

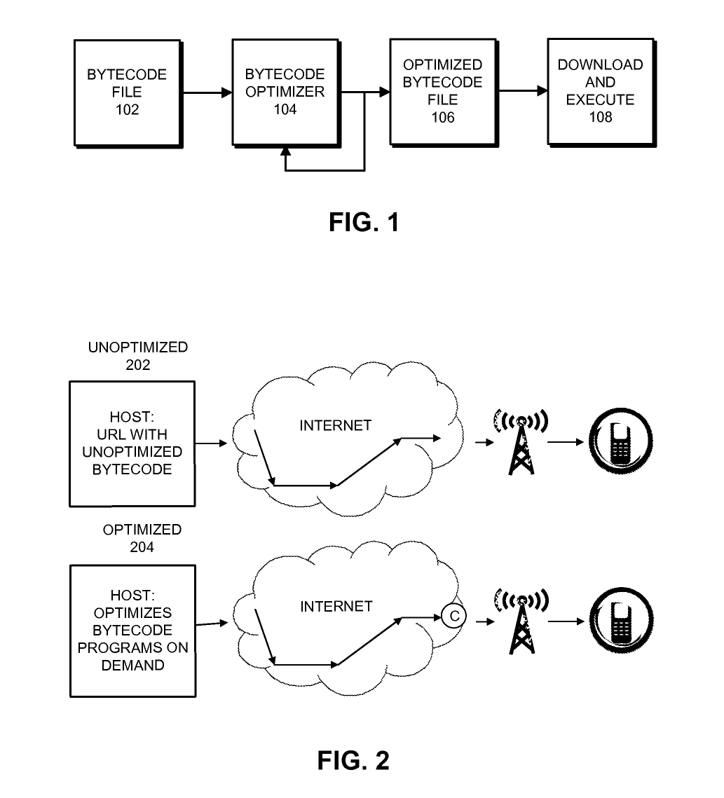

A black box view of the process appears in FIG. 1. The original instruction code is in a file such as bytecode file 102. Bytecode file 102 passes through a bytecode optimizer 104 and a new file 106 is created that contains optimized instruction code which can then be downloaded and executed 108. During the optimization process, compiler optimizations are applied to restructure the program so that it runs faster on all systems that the instruction code would have run on. The file is likely also to be smaller in size. Moreover, optimally performing syntactic structures can be replaced with syntactically equivalent structures. Note that this new optimized file can be created any time the original instruction code file is modified at source code compilation time.

Computer programming languages that produce bytecode intended for JIT compilers can benefit from the same techniques. Such languages can be reduced to bytecode, statically optimized, and emitted as optimized code that can be processed the same way as the original file. Hence, these static optimizations serve as an adjunct to just-in-time compilation. This gives the resultant code the advantages of both static and JIT optimizations.

Note that the instruction code retains much source code information even after it is compiled to bytecode or machine code. This includes information such as a source file name; variable, method, argument, and field names; and line numbers. Though useful for debugging, this information also allows for decompilation and reverse engineering entire programs. Tools to do this are easily found on the Internet, and source code which is reconstructed using such techniques is often exact. Usually this is neither welcomed nor desired by the owner.

Optimization of instruction code inside and across methods requires control and data flow analysis, semantic and syntactic analysis, liveness analysis, etc. As a result of such analyses, various optimizations can be performed which can include but are not limited to the following:
1. Evaluating constant expressions;
2. Removing unnecessary field accesses;
3. Removing unnecessary method accesses;
4. Removing unnecessary branches;
5. Removing unnecessary comparisons;
6. Removing unnecessary instanceof tests;
7. Removing unused code blocks;
8. Reducing variable allocation;
9. Removing write-only fields;
10. Removing unused method parameters;
11. Inlining constant fields;
12. Inlining method parameters;
13. Inlining return values;
14. Inlining short methods that are called once;
15. Simplifying tail recursion calls;
16. Merging classes;
17. Merging interfaces;
18. Making methods private, static, and final whenever possible;
19. Making classes static and final whenever possible;
20. Replacing interfaces that have single implementations;
21. Performing peephole optimizations;
22. Hoisting constant expressions out of loops; and
23. Performing loop escape analysis.

Because static compiler optimization can be time consuming, one might think that it should not be performed in real-time. However, real-time static compilation may be beneficial when the results of compilation can be cached on servers for subsequent references or downloads. The first user access of a page that uses unoptimized instruction code can incur the performance cost of static compiler optimization and the optimized instruction code cached on a server while sending the optimized program to the end user's browser. However, subsequent references do not need to re-optimize. Instead, the cached optimized program(s) can be downloaded. In this way, the cost of real-time optimization is amortized across all subsequent references.

Real-time optimization and caching can be performed at one of many servers during the transmission of an unoptimized program. An application of real-time optimization and caching for reuse occurs in wireless Internet traffic. With the proliferation of smartphones, demand for wireless bandwidth is increasing. Wireless service providers must increase their capacity to deliver traffic or their customers will suffer reduced performance. They can do this by petitioning the FCC for additional channels, an expensive proposition, or by reducing service demands for bandwidth.

If we assume that the programs to be downloaded comprise unoptimized instruction code on the system that hosts it, then the service demand to download the pages will be greater than if the pages are optimized as described herein. Furthermore, the processor cores in mobile devices are slow to reduce the drain on battery life. This is a performance characteristic that is well-known in the embedded space. Given that an unoptimized program takes longer to execute than an optimized program, the positive effects of an optimized program in the embedded space and mobile devices in particular are greatly magnified when compared with desktop and laptop systems.

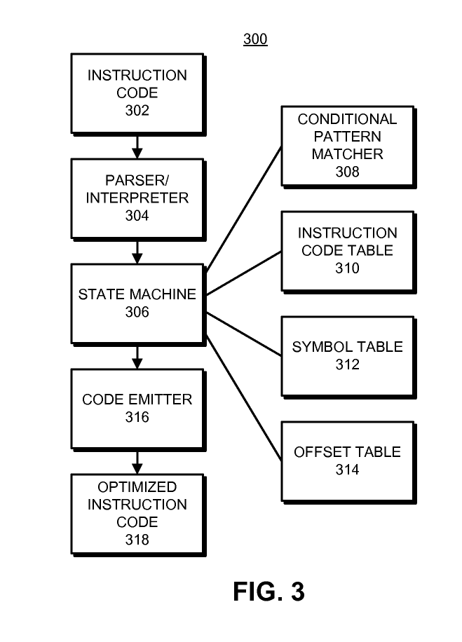

The illustration in FIG. 2 shows two scenarios: unoptimized 202 and optimized 204. The unoptimized 202 scenario has a URL with unoptimized programs. Whenever a request is made for the URL, the HTML with an unoptimized program is transferred to a mobile computing device (e.g., a browser equipped cell phone), and the transfer of the optimized program requires a significant amount of time. Among the reasons for this are long function and variable names, comments, transfer of dead code, etc. More bandwidth is required to transfer everything needed for the page over the Internet and wireless. As a result, there is more contention for resources, more queuing, and longer response times. Whenever the unoptimized programs arrive at the mobile computing device, time is required to read, parse, and execute the program.

In the optimized case 202, the same page is transferred across the Internet. At some compute node along its route, the page is recognized to contain an unoptimized program, and the compute node optimizes the program. The compute node then caches the optimized program and transfers it to the next node and eventually to the personal compute device. Note that the compute node adds latency while optimizing the program. However, any subsequent references to the program on that compute node do not incur the optimization cost again (unless the page or program changes and the corresponding cache entry is invalidated). Moreover, the size of the program being transferred is smaller. This results in lower demand for bandwidth, less queuing, and faster response times. Also, the personal compute device's browser does less work and processing is more efficient and faster. Among other advantages, the tokens to be parsed are smaller; dead code and comments are not present; and aliasing, function inlining, and loop optimization are performed. Furthermore, caching improves locality and fewer network hops are necessary on subsequent accesses. This means that wireless Internet service providers have less need to add costly wireless channels and infrastructure.

The two scenarios illustrated in FIG. 2 with wireless and personal compute devices also apply to other clients with browsers (e.g., laptops, desktops, or enterprise servers) and to other physical network media and protocols (e.g., dial-up, DSL, fiber optics, or T1 connections). The further upstream in the data transfer that program optimization can be performed, the lower the network utilization and the faster the data transfers will occur. A preferred solution is to have the optimized programs reside on the host; nevertheless, optimizing and caching the optimized program in transit will still result in faster response times, less queuing, and lower service demands for network and compute resources on subsequent references.

We now describe details of some embodiments of the present invention.

### System

FIG. 3 illustrates a system 300 which performs the optimization process in accordance with the disclosed embodiments. System 300 receives instruction code 302, which as mentioned above can include platform-independent bytecode, machine-specific executable code or even source code. Next, a parser/interpreter 304 reads instruction code 302, and if necessary interprets source code into a lower-level intermediate form or into executable code. Next, a state machine 306 performs optimizations on the code. During this process, state machine 306 populates a symbol table 312 and an instruction code table 310. State machine 306 also maintains an offset table 314 which keeps track of offsets for objects which have been relocated during the optimization process. State machine 306 additionally uses a conditional pattern matcher 308 to find optimization opportunities and applies the relevant optimizations. Finally, after all of the relevant optimizations are applied, code emitter 316 emits optimized instruction code 318.

### Optimization Process

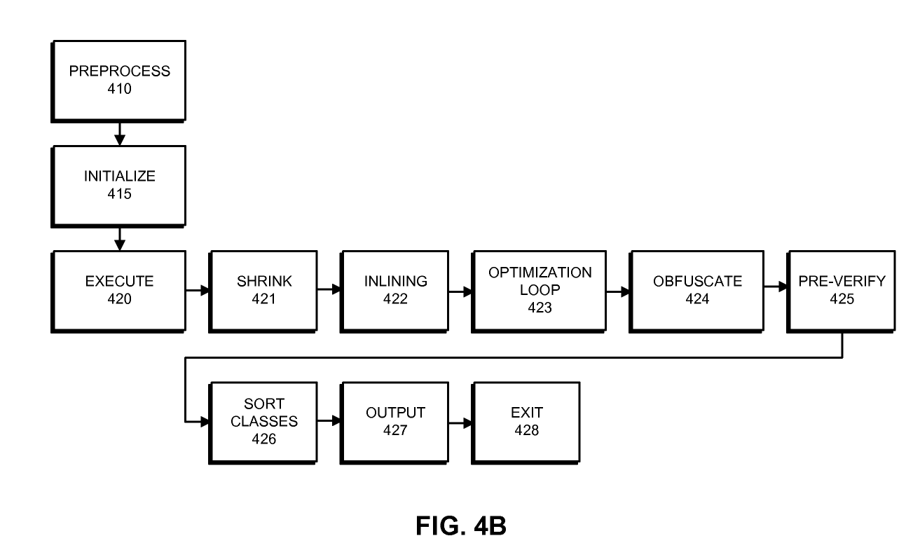

FIGS. 4A and 4B illustrate steps involved in the optimization process in accordance with the disclosed embodiments. Referring to FIG. 4A, the system first obtains the instruction code (step 402), wherein the instruction code was previously generated from source code, and wherein the instruction code is stored along with symbol table information. Next, the system constructs a symbol table from the symbol table information stored along with the instruction code (step 404). The system also creates an instruction code table for the instruction code (step 406), wherein the instruction code table contains a call graph for the instruction code, and wherein creating the instruction code table involves accessing the symbol table. Finally, the system performs optimizations on the instruction code to produce optimized instruction code (step 408), wherein performing the optimizations involves accessing the instruction code table.

FIG. 4B provides more detailed steps involved in the optimization process in accordance with the disclosed embodiments. First, during a pre-processing operation (step 410), the system examines which optimization “switches” are set to specify various optimizations options. Next, during an initialization operation (step 415), the system initializes various data structures which are used to perform the optimization operations.

Finally, during an execute process (step 420),the system performs a number of optimizations, which can include, but are not limited to the following operations. A shrink operation removes “cruft,” such as unused parameters and unused codes (step 421). An inlining operation performs various inlining operations (step 422), which for example can involve replacing calls to short methods with equivalent in-line code. An optimization loop is executed to apply a large number of different optimization operations to the code (step 423). Next, an obfuscation process is applied to obfuscate the code to make it harder to decompile (step 424). (For example, the obfuscation process can involve converting all class labels, method names and variables into non-descriptive identifiers, such as A, B, C, . . . ) The system also performs a pre-verification operation to verify that the code is properly formed and will execute correctly (step 425). (For example, the pre-verification operation can verify that types match.) Finally, the system sorts the classes (step 426) and then outputs the classes (427) to produce the optimized instruction code and then the process exits (step 428).

### State Machine

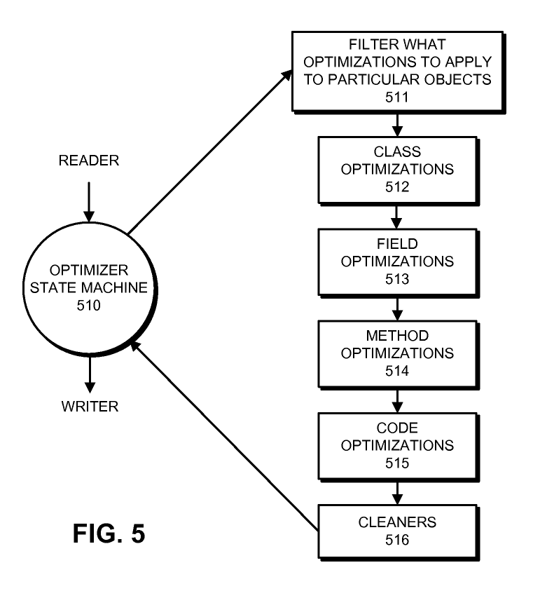

FIG. 5 illustrates operations performed by an optimizer state machine 510 which performs the optimization operations mentioned in step 423 in the flow chart in FIG. 4 in accordance with the disclosed embodiments.

Optimizer state machine 510 first performs a filtering operation to determine which optimizations to apply to specific objects (step 511). Performing these optimizations can involve performing class optimizations (step 512), field optimizations (step 513), method optimizations (step 514) and code optimizations (step 515). The system also performs a cleaning step to remove cruft (step 516).

### Files and Data Structures

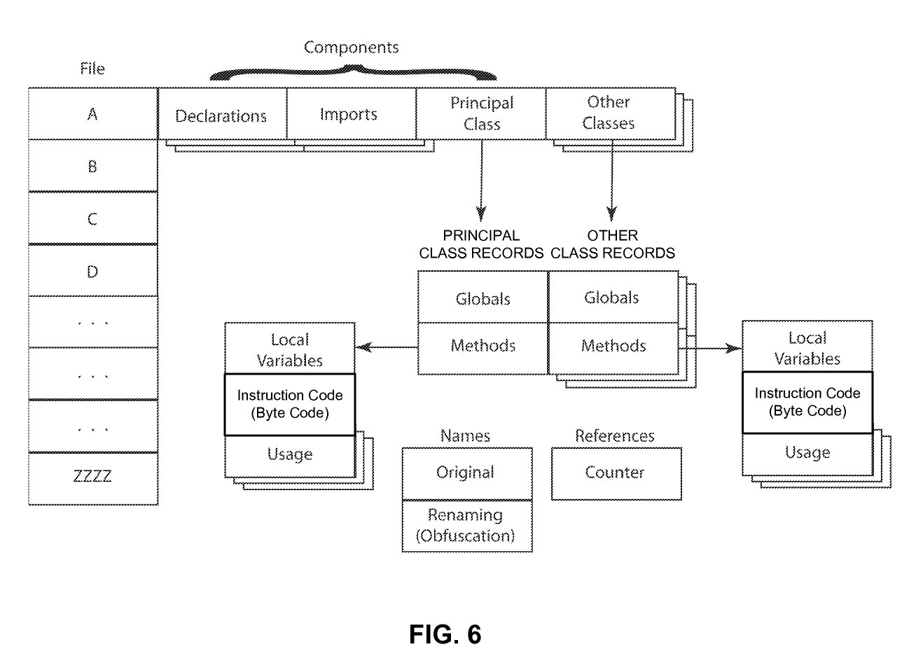

FIG. 6 illustrates files and data structures involved in the optimization process in accordance with the disclosed embodiments. A program to be optimized comprises a set of files A, B, C, . . . ZZZZ which appear on the left-hand side of FIG. 6. As illustrated in FIG. 1, a given file, such as file A specifies a number of components, including declarations, imports, principle classes and other classes. Note that the principal classes point to principal class records, and the other classes point to other class records. These class records include local variables, instruction code, and usage information. For example, the usage information can include a count of how many times a method is accessed. The system also maintains a data structure which includes original names for objects and also renaming information, which is useful for mapping original names to obfuscated names for objects. The system additionally maintains counter information which, for example, can keep track of external references to objects, such as variables and methods. This information can be used to determine which objects to throw away during the optimization process. Note that when an external object is referenced and the external object resides within another file, the system processes the other file.

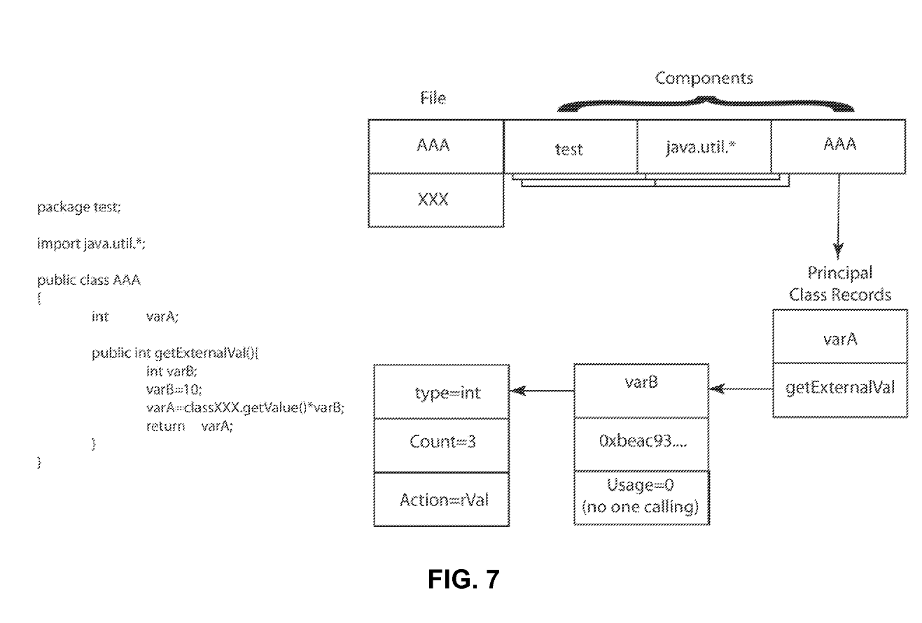

FIG. 7 illustrates a portion of a data structure for an exemplary piece of code in accordance with the disclosed embodiments. In this example, a file AAA contains a component “test.” AAA is populated for the principal class and then varA is populated. Next, a getExternVal class is populated and inside the getExternVal class varB is populated with type int. Note that varB appears three times in the class, so the count for varB is 3. varB is also used on the right-hand side of an equation to multiply the classXXX.getvalue( ) so varB is associated with an action rVal. Next, since there is a call to classXXX, the system proceeds to the file for classXXX, which causes this file to be processed similarly.

### Optimizations

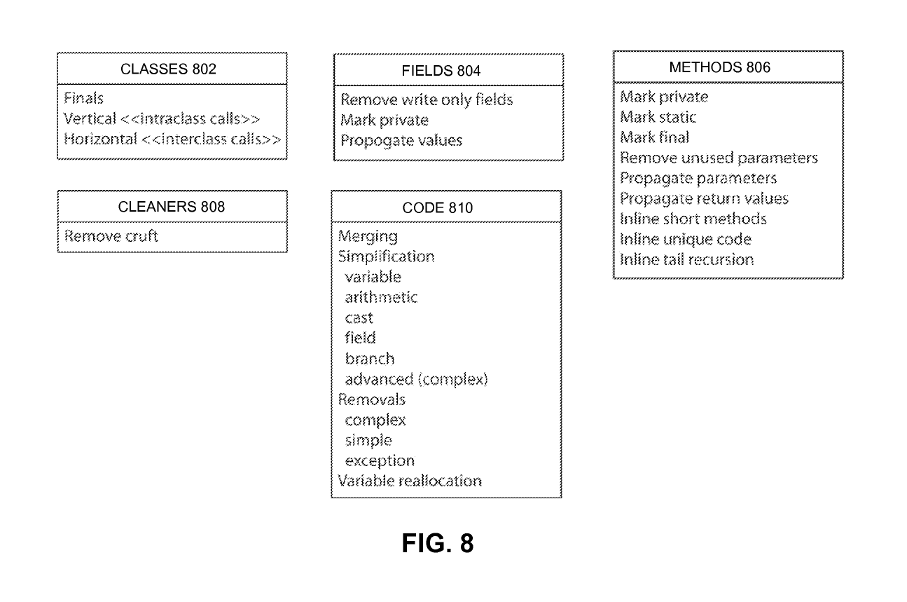

FIG. 8 illustrates exemplary optimizations applied to various objects in accordance with the disclosed embodiments. For classes 802, the system finalizes methods to improve performance, and also optimizes “vertical” intra-class calls and “horizontal” inter-class calls. For fields 804, the system removes write only fields, marks objects as private and propagates values. For methods 806, the system marks privates, marks statics, marks finals, removes unused parameters, propagates parameters, propagates return values, and inlines short methods, unique code and tail recursions. For code 810, the system merges code and performs simplification operations, removals of unnecessary objects and variable reallocations. Also, the cleaners 808 remove cruft, such as unused code and unused variables.

In addition to the above-listed optimizations, the system can perform a number of other optimizations, including but not limited to the following:
(1) Eliminating components (e.g., objects, classes, variables, interfaces, etc.) that are irrelevant to the functionality of the program.
(2) Instantiating a code optimizer that analyzes instruction code. This analysis includes, but is not limited to, control-flow, data flow, semantic, syntactic, and liveness analysis.
(3) Performing optimizations such as removing dead code and variables, improving loops by hoisting invariants, loop unrolling, applying transformations to control-flow and data-flow, reusing variables, eliminating common sub-expressions, reducing copy propagation, inlining functions, dropping unnecessary induction variables from loops, algebraic transformations, and aliasing.
(4) Eliminating unused classes, methods, variables, fields, and the like from instruction code. All tokens are identified. Unused tokens are eliminated.
(5) Wherever possible replacing instruction code with constants (e.g.,) sin(45°)=sin(πn/4) is replaced by 0.707106, where the argument expected by sin is radians).
(6) Optimizing local and global variables. This requires that usage of variables in instruction code be analyzed. Global values can be cloned to local variables to optimize accesses. Conversely, local variables can be converted to global to avoid recalculation in methods. Instruction code is rewritten and maintained.
(10) Eliminating unnecessary field accesses from instruction code. As an artifact of the object paradigm, field objects may be created and manipulated but never used by the program. These artifacts are eliminated.
(11) Removing unnecessary method accesses from instruction code. As an artifact of the object paradigm, methods may be needlessly accessed but never use the results or what is modified. These artifacts are eliminated.
(12) Removing unnecessary branches from instruction code. For example, static analysis may show that a branch is always taken because the alternative condition is never reached. The branch can be removed together with associated alternative code paths.
(13) Removing unnecessary instanceof tests from the instruction code.

A static analysis may show that there are no alternatives to the class of a variable. If and only if a variable can represent only one class, the instanceof test can be removed. A simple example is shown in a Java code sample that javac will reduce to bytecode.

```
public class MainClass {
  public static void main(String[ ] a) {
    String s = “Hello”;
    if (s instanceof java.lang.String) {
      System.out.println(“is a String”);
    }
  }
}
```

This instanceof test in Java is always true and can only represent one class; therefore, it can be eliminated from the bytecode.

```
public class MainClass {
  public static void main(String[ ] a) {
    String s = “Hello”;
      System.out.println(“is a String”);
  }
}
```

(14) Removing unused code blocks from instruction code.
(15) Removing variable allocations from instruction code. For example, if an integer variable is used for a short duration in a method followed by the use of another integer that does not overlap the use of the first, then the second variable can be dropped and the first variable reused. Such optimizations take pressure off memory management in the virtual machine.
(16) Removing write only fields from instruction code. Fields that are never read are removed because they are functionally unused by the program.
(17) Removing unused method parameters from instruction code. The overhead of passing parameters (especially as related to object creation and memory management) is unnecessary if the result of the work is unused in a method. Whenever a parameter is determined to be unused within a method, the parameter is eliminated.
(18) Inlining constant fields in instruction code.
(19) Inlining method parameters in instruction code Inlining removes the performance overheads of setting up a function call, performing the return, and function tear down. It improves cache performance by improving locality of reference. In addition, the inlined callee body may be subject to additional optimization with the caller.
(20) Inlining return values in instruction code.
(21) Inlining short methods in instruction code Inlining removes the performance overheads of setting up a function call, performing the return, and function tear down. It also improves cache performance by improving locality of reference. In addition, the inlined callee body may be subject to additional optimization within the caller.
(22) Inlining methods in loop constructs detected in instruction code. If the method is outside the class, the lookup is an expensive operation during each iteration through the loop. By inlining the method, the overheads of calling a method in a different class are eliminated from the loop.
(23) Simplifying tail recursion calls in instruction code. These are transformed to iterations. Replacing recursion with iteration can drastically decrease the amount of stack space used and improve efficiency. No state except for the calling function's address needs to be saved, either on the stack or on the heap. This reduces pressure on memory management and usage (running out of stack or heap space) in the virtual machine due to extremely deep recursions.
(24) Merging classes in instruction code. Programmers commonly have classes that call methods in other classes that are not fully instantiated. In such cases, the overheads associated with the called class are unnecessary and the class can be merged with the caller by inlining
(25) Merging interfaces in instruction code. Programmers commonly have classes that call interfaces. In such cases, the overheads associated with the called interface are unnecessary and the interface even when partially implemented can be merged with the caller by inlining Certain JVMs have limitations on the number of interfaces and other JVMs degrade performance.
(26) Optimizing class specification and class filtering. The optimizer understands class calling conventions. This determines the scope of optimization.
(27) Making methods private, static, and final in instruction code wherever possible.
(28) Making classes static and final in instruction code wherever possible.
(29) Removing interfaces that have single implementations within the interface.
(30) Hosting constant expressions out of loops in instruction code.
(31) Performing loop escape analysis in instruction code. A statement inside the loop may have a test condition that allows early exit. Whenever an exit test contains a variable, JIT compilation may be disabled.
(32) Converting loops to constant loops whenever possible. This allows bytecode to benefit from JIT compilation that would otherwise not have occurred.
(33) Emitting optimized instruction code from the code generator. The emitted optimized instruction code is chosen from the most efficient code construct among the programming constructs that are functionally equivalent. For example, equivalent code can be written using for( ) and while( )-do loops; however, one control statement might execute more efficiently because of the underlying implementation. Whenever the code emitter must choose between functionally equivalent alternatives, the choice will be made based on empirical data. Whenever variables have limited use in a function, it may be possible to reuse a variable for another purpose rather than create a new one. The optimized instruction code executes faster than the original.
(34) Performing peephole optimization of instruction code.
(35) Restructuring instruction code to optimize execution time. This is accomplished by such techniques as dead code removal, peep hole optimization, loop unrolling or restructuring, hoisting invariants above loops, etc.
(36) Optimizing instruction code using thread level parallelism.
(37) Directly manipulating and reorganizing instruction code without changing behavior even though unnecessary or redundant instruction code is removed, instruction code is reorganized, or instruction code is replaced.
(38) Performing pattern recognition to optimize instruction code. For example, variables may be pushed on the stack before method calls and popped from the stack after method calls. Two methods using the same stack variables can be optimized by removing operations that undo each other.
(39) Renaming labels using program scoping rules using shorter strings.
(40) Creating a symbol table. If desired, this table can be used to emit function and variable name mappings between the original and new program instruction code. The symbol table may also be output to a file and used for debugging and to cross reference between the original instruction code and the optimized instruction code.
(41) Eliminating synchronization primitives from instruction code wherever safe.
(42) Optimizing generic machine code for real machines by rewriting machine code to take advantage of multiple threads, cores, or processors.
(43) Optimizing generic machine code for real machines by rewriting machine code to take advantage of ancillary hardware such as a graphic processor unit's registers and cores.
(44) Optimizing generic machine code for real machines by structuring variables to take advantage of memory architecture such as cache block size, associativity, and hierarchy.
(45) Optimizing generic machine code for real machines to use hardware accelerators (e.g., SSL hardware, on-chip TPC/IP, etc.), specialized instructions (e.g., trig functions implemented as machine instructions, etc.), new instructions (e.g., instructions that the original machine code is ignorant of), etc.
(46) Obfuscating the program and making reverse engineering more difficult. In the obfuscation process all debugging information is replaced by seemingly meaningless character strings. A cross-reference is available to developers for debugging exception stack traces. Unobfuscated code can be used for profiling so inefficient algorithms can be identified and improved.
(47) Modifying function and variable names to obfuscate instruction code for security and compactness. For example, a( )might be the function name that is used instead of foobar( ) and b might be the variable name that is used instead of loopCounter. Upper [A-Z] and lower [a-z] alphabetic characters are used exclusively. No distinction is made among method, variable, and class when the label is constructed. First one-letter labels are constructed (e.g., ‘A’, ‘B’, ‘C’, . . . , ‘x’, ‘y’, ‘z’). Next two-letter labels are constructed (e.g., ‘AA’, ‘AB’, ‘AC’, . . . , ‘zx’, ‘zy’, ‘zz’). Next, three-letter labels are constructed (e.g., ‘AAA’, ‘AAB’, ‘AAC’, . . . , ‘zzx’, ‘zzy’, ‘zzz’). The pattern continues for four, five, six or more letters as required by the symbol table. Alternatively, instead of appending letters to a base, letters could be prepended (e.g., ‘A’, ‘B’, ‘C’, . . . , ‘x’, ‘y’, ‘z’, ‘AA’, ‘BA’, ‘CA’, . . . , ‘xz’, ‘yz’, ‘zz’, ‘AAA’, ‘BAA’, ‘CAA’, . . . , ‘xzz’, ‘yzz’, ‘zzz’, . . . ). The code becomes almost indecipherable with labels like ‘aBXq’ and ‘jdRnQ’. Introduction of numerics improves the ability of humans to recognize patterns.
(48) Using language scoping rules to limit the number of labels. For example, if the scope of a variable is a method, then the variables within the method can have labels that start from the beginning of the labeling pattern. Or, methods within a class can have labels that start at the beginning of the labeling pattern. For example, the optimized program can have a class named ‘A’ with a method ‘A’ call interface ‘A’ to access variable ‘A’ in method ‘A’ in a different class named ‘A’. The application of scoping rules to label renaming makes this possible.
(49) Removing line numbers and tracing information to make reverse engineering more difficult.
(50) Preventing user-defined classes from being obfuscated. This is important because programs have defined entry points (e.g., main( )). There may be multiple entry points specified in a multithreaded program. These cannot be obfuscated if the program is to execute properly.
(51) Outputting a file that maps between the original program labels and the obfuscated program labels (e.g., names of classes, methods, variables, etc.).
(52) Optimizing the speed to load class files and archives by verifying that the bytecode cannot break on the virtual machine or the machine code cannot break on the real machine.
(53) Performing static checking including, but not limited to, type, flow-of-control, uniqueness, and name-related checks.
(54) Determining if the input instruction code is well formed and unambiguous. Semantic ambiguities or errors are identified clearly and accurately so the programmer can make appropriate corrections to the source code.
(55) Using a grammar for the optimized instruction code. The optimized instruction code that is emitted by the compiler uses the same grammar as that used to verify the input syntax and semantics and create the state machine.
(56) Parsing instruction code that reports syntactic and semantic errors. The parser exits whenever it is unable to proceed because of the errors or whenever a threshold is reached. This allows the programmer to correct errors prior to optimization and code emission. This results in robust code that does not contain syntactic and semantic errors. Statements are syntactically and semantically correct, eliminating run-time errors and error recovery.
(57) Re-targeting older versions of class files to newer versions of the virtual machine.
(58) Reducing variable and function name lengths by renaming. For programs that are downloaded from a host to a client system, the bandwidth is reduced and download times are faster.
(59) Optionally removing line numbers and tracing information. The optimized program is more compact and faster.
(60) Placing an identifier in the instruction code to mark that it is optimized. This prevents redundant optimizations of instruction code. This is especially useful in distributed environments.
(61) Running on a distributed network host to create optimized instruction code.
(62) Optimizing instruction code while it is in transit through a network at a node. This node can cache the optimized instruction code locally or at well-known locations for future users. The cached instruction code can be replaced whenever newer instruction code is available from the original host.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for globally optimizing instruction code, comprising:
obtaining the instruction code, wherein the instruction code was previously generated from source code, and wherein the instruction code is stored along with symbol table information;
constructing a symbol table from the symbol table information stored along with the instruction code;
creating a data structure for the instruction code, wherein the data structure contains a call graph for the instruction code, and wherein creating the data structure involves accessing the symbol table; and
performing optimizations on the instruction code to produce optimized instruction code, wherein performing the optimizations involves accessing the data structure.

2. The method of claim 1, wherein the instruction code is either platform-independent byte code or architecture-specific machine code.

3. The method of claim 1, wherein obtaining the instruction code involves interpreting the source code to produce the instruction code.

4. The method of claim 1, wherein constructing the symbol table involves:
constructing a list of classes which includes attributes of the classes; and
determining an entry point for the instruction code.

5. The method of claim 1, wherein creating the data structure for the instruction code involves storing methods and variables from the instruction code in the data structure.

6. The method of claim 1, wherein the method further comprises performing a shrinking operation on the instruction code, wherein performing the shrinking operation involves removing unnecessary code and variables and also relocating code and variables and updating associated pointers.

7. The method of claim 1, wherein performing the optimizations on the instruction code involves one or more of the following:
removing dead code and variables;
hoisting loop invariants;
loop unrolling;
applying transformations to control-flow and data-flow;
reusing variables;
eliminating common sub-expressions;
reducing copy propagation;
inlining functions;
dropping unnecessary induction variables from loops;
algebraic transformations; and
choosing an efficient code construct from multiple functionally equivalent code constructs.

8. The method of claim 1, wherein producing the optimized instruction code additionally involves obfuscating the instruction code.

9. A non-transitory computer-readable storage medium storing instructions that when executed by a computer cause the computer to perform a method for globally optimizing instruction code, the method comprising:
obtaining the instruction code, wherein the instruction code was previously generated from source code, and wherein the instruction code is stored along with symbol table information;
constructing a symbol table from the symbol table information stored along with the instruction code;
creating a data structure for the instruction code, wherein the data structure contains a call graph for the instruction code, and wherein creating the data structure involves accessing the symbol table; and
performing optimizations on the instruction code to produce optimized instruction code, wherein performing the optimizations involves accessing the data structure.

10. The computer-readable storage medium of claim 9, wherein the instruction code is either platform-independent byte code or architecture-specific machine code.

11. The computer-readable storage medium of claim 9, wherein obtaining the instruction code involves interpreting the source code to produce the instruction code.

12. The computer-readable storage medium of claim 9, wherein constructing the symbol table involves:
constructing a list of classes which includes attributes of the classes; and
determining an entry point for the instruction code.

13. The computer-readable storage medium of claim 9, wherein creating the data structure for the instruction code involves storing methods and variables from the instruction code in the data structure.

14. The computer-readable storage medium of claim 9 wherein the method further comprises performing a shrinking operation on the instruction code, wherein performing the shrinking operation involves removing unnecessary code and variables and also relocating code and variables and updating associated pointers.

15. The computer-readable storage medium of claim 9, wherein performing the optimizations on the instruction code involves one or more of the following:
removing dead code and variables;
hoisting loop invariants;
loop unrolling;
applying transformations to control-flow and data-flow;
reusing variables;
eliminating common sub-expressions;
reducing copy propagation;
inlining functions;
dropping unnecessary induction variables from loops;
algebraic transformations; and
choosing an efficient code construct from multiple functionally equivalent code constructs.

16. The computer-readable storage medium of claim 9, wherein producing the optimized instruction code additionally involves obfuscating the instruction code.

17. A system that globally optimizes instruction code, comprising:
an instruction code parser configured to parse the instruction code, wherein the instruction code was previously generated from source code, and wherein the instruction code is stored along with symbol table information;
a symbol table construction mechanism configured to construct a symbol table from the symbol table information stored along with the instruction code;
an instruction code table creation mechanism configured to create an instruction code table for the instruction code, wherein the instruction code table contains a call graph for the instruction code, and wherein creating the instruction code table involves accessing the symbol table; and
a state machine configured to facilitate performing optimizations on the instruction code to produce optimized instruction code, wherein performing the optimizations involves accessing the instruction code table.

18. The system of claim 17, wherein the instruction code is either platform-independent byte code or architecture-specific machine code.

19. The system of claim 17, wherein obtaining the instruction code involved interpreting the source code to produce the instruction code.

20. The system of claim 17, further comprising a shrinking mechanism configured to perform a shrinking operation on the instruction code, wherein the shrinking operation removes unnecessary code and variables and also relocates code and variables and updates associated pointers.

21. The system of claim 17, further comprising a conditional pattern-matching mechanism configured to match patterns in the instruction code to facilitate finding optimization opportunities.

22. The system of claim 17, wherein the system is configured to use an offset table to manage code rewriting operations.

23. The system of claim 17, further comprising an obfuscation mechanism configured to obfuscate the optimized instruction code.
